(19) United States
(12) Patent Application Publication
(10) Pub. No.: US 2020/0131322 A1
(43) Pub. Date: Apr. 30, 2020

(54) FILM, METHOD FOR EVALUATING OPTICAL HOMOGENEITY OF FILM, AND FILM PRODUCTION METHOD

(71) Applicant: SUMITOMO CHEMICAL COMPANY, LIMITED, Tokyo (JP)

(72) Inventors: Mitsunori NODONO, Tsukuba-shi (JP); Masayoshi KARASAWA, Tsukuba-shi (JP); Akiko KISHIDA, Tsukuba-shi (JP); Masami MAKIDERA, Tsukuba-shi (JP); Junichi IKEUCHI, Tsukuba-shi (JP)

(73) Assignee: SUMITOMO CHEMICAL COMPANY, LIMITED, Tokyo (JP)

(21) Appl. No.: 16/619,013

(22) PCT Filed: May 30, 2018
(86) PCT No.: PCT/JP2018/020703

§ 371 Date: Dec. 3, 2019

(30) Foreign Application Priority Data
Jun. 5, 2017 (JP) 2017-110960
Mar. 22, 2018 (JP) 2018-055012

(51) Int. Cl. C08J 5/18; B29D 11/00; C08G 73/10; C08G 73/14; G01N 21/958

(52) U.S. Cl. CPC C08J 5/18; B29D 11/00788; B29K 2079/085; C08G 73/14; G01N 21/958; C08G 73/1067

(57) ABSTRACT

A film having excellent optical homogeneity, which is suitably used as an optical film in an image display device, and a method for manufacturing the same. Moreover, an evaluation method which can evaluate the optical homogeneity of the film with a higher precision than in conventional evaluation methods is provided. A film that is a cast film containing a resin having a weight average molecular weight of 200,000 or more, wherein, when line profiles in a direction h and a direction v which are orthogonal to each other in a film inverse space image obtained by Fourier transforming a projection image obtained by a projection method using the cast film are a line profile h and a line profile v.

### TECHNICAL FIELD

The present invention relates to a film, a method for evaluating the optical homogeneity of the film, and a method for manufacturing the film.

### BACKGROUND ART

An optical film used in an image display device such as a liquid crystal display device or an organic EL display device is required to have very high optical homogeneity because users visually recognize a displayed image directly through the optical film.

As a method for manufacturing such an optical film, a method in which a solution containing a volatile solvent and a resin constituting the optical film is applied onto a substrate, dried, and then peeled off (for example, Patent Document 1). In such a manufacture method involving coating and drying, uneven thickness and uneven alignment may occur depending on the coating conditions and drying conditions. Even when the film has such a level of unevenness that cannot be visually confirmed, when the film is finally incorporated as an optical film in an image display device, the optical homogeneity may be impaired due to such unevenness, so that the distortion of the image or the like may be visually recognized. Therefore, a film used as an optical film in an image display device is required to have quite high-precision homogeneity at a level difficult to confirm visually. Thus, there is still a need for further improvement in the optical homogeneity of the film.

As an optical film with suppressed unevenness, for example, Patent Document 1 describes a polyimide-based optical film in which, in a rectangular area cut from a projection image thereof, a standard deviation σ of a gray scale and an area of a black portion in a binarized image of the rectangular area are adjusted within predetermined ranges. Patent Document 2 describes an optical transparent film in which the variation in luminance of transmitted light within the film plane is within 15% of the average luminance in terms of standard deviation. Patent Document 3 describes a shape measuring method by a fringe projection method involving irradiating light from a light source unit onto a lattice plate, projecting light transmitted through the lattice plate as a lattice image, photographing the lattice image, and quantifying the three-dimensional system shape of the object to be measured from the distortion of the lattice image.

### PRIOR ART DOCUMENTS

### Patent Documents

Patent Document 1: WO 2016/152459
Patent Document 2: JP H9-48866 A
Patent Document 3: JP 2011-226871 A

### SUMMARY OF THE INVENTION

### Problems to be Solved by the Invention

However, all of the methods described in the above-mentioned patent documents cannot be said to be sufficient to evaluate the optical homogeneity of a film with very high accuracy required of a film used as an optical film in an image display device. The method described in Patent Document 1 is intended for evaluation in an analysis area of 1 cm×5 cm, and thus is not a method that can sufficiently evaluate a decrease in optical homogeneity caused by unevenness that occurs in the vertical direction. The method described in Patent Document 2 is not a method that can accurately evaluate a decrease in optical homogeneity caused by light-shade unevenness with a small difference in luminance of transmitted light.

The method described in Patent Document 3 is a method for detecting the shape, and thus cannot evaluate a decrease in optical homogeneity due to refractive index unevenness. Therefore, none of the films obtained through evaluation by these methods can be said to have sufficient optical homogeneity.

Accordingly, the present invention has been made in view of the above-described problems of the prior art, and provides a film having excellent optical homogeneity, which is suitably used as an optical film in an image display device, and a method for manufacturing the film. Moreover, an object of the present invention is to provide an evaluation method which can evaluate the optical homogeneity of a film with higher precision than in conventional evaluation methods.

### Means for Solving the Problems

In order to solve the above-mentioned problems, the present inventors diligently studied a method for improving the optical homogeneity of an optical film and a method for evaluating the optical homogeneity. As a result, focusing on an inverse space image obtained by Fourier transform from a projection image of a film by a projection method, the inventors have found that a film satisfying specific requirements has excellent optical homogeneity, and have completed the present invention.

That is, the present invention includes the following suitable embodiments.

[1] A cast film containing a resin having a weight average molecular weight of 200,000 or more,

wherein, when line profiles in a direction h and a direction v which are orthogonal to each other in a film inverse space image obtained by Fourier transforming a projection image obtained by a projection method using the film are line profiles h and v, respectively;

line profiles in a direction h′ and a direction v′ which are orthogonal to each other in a background inverse space image obtained by Fourier transforming a background image obtained without using the film in the projection method are line profiles h′ and v′, respectively;

a maximum intensity of a line profile (h−h′) obtained by subtracting the line profile h′ from the line profile h is Yₘₕ;

a frequency indicating the maximum intensity Yₘₕ is Xₘₕ;

a maximum intensity of a line profile (v−v′) obtained by subtracting the line profile v′ from the line profile v is Yₘᵥ; and

a frequency indicating the maximum intensity Yₘᵥ is Xₘᵥ,

Yₘₕ and Yₘᵥ are both 30 or less, and Yₘₕ, Yₘᵥ, Xₘₕ and Xₘᵥ satisfy the following relationship:

(Yₘₕ+Yₘᵥ)/(Xₘₕ+Xₘᵥ)^{1/2}<20 [Mathematical Formula 1].

[2] The film according to [1], wherein the resin is polyimide or polyamideimide.
[3] A method for evaluating the optical homogeneity of a film, comprising at least the steps of:

(1) obtaining a projection image by a projection method in which light from a light source is irradiated onto a film and light transmitted through the film is projected onto a projection plane;

(2) projecting light from the light source onto the projection plane without using the film in the projection method of step (1) to obtain a background image;

(3) quantifying each of the projection image obtained in step (1) and the background image obtained in step (2) through gray scale conversion and Fourier transforming the quantified image data to obtain inverse space images;

(4) subtracting line profiles in two directions orthogonal to each other in the inverse space image of the background image from line profiles in the two directions orthogonal to the inverse space image of the projection image to obtain blank-corrected line profiles; and

(5) measuring maximum intensities (Yₘₕ and Yₘᵥ) of the blank-corrected line profiles obtained in step (4).

[4] A method for manufacturing a film, comprising at least the steps of:

applying a varnish containing at least a resin and a solvent to a support;

drying the varnish coating to obtain a film, and

evaluating the film using the method for evaluating according to [3].

[5] The method for manufacturing a film according to [4], wherein, in the step of evaluating the film, the optical homogeneity of the film is evaluated based on the maximum strengths (Yₘₕ and Yₘᵥ) measured by the method for evaluating according to [3], and the quality of the film is determined.

### Effect of the Invention

The present invention can provide a film having excellent optical homogeneity and a method for manufacturing the film. In addition, the present invention makes it possible to evaluate the optical homogeneity of the film with higher accuracy than in conventional evaluation methods.

### BRIEF DESCRIPTION OF THE DRAWINGS

FIG. 1 is a schematic diagram showing an arrangement example in the step of obtaining a projection image.

FIG. 2 is a schematic diagram illustrating an arrangement in the step of obtaining projection images in Examples and Comparative Examples.

FIG. 3 is a diagram for explaining Yₘₐₓ, Xₘₐₓ and X_{cen} in a line profile.

FIG. 4 is a diagram showing a line profile before normalization obtained from the projection image of Example 1.

FIG. 5 is a diagram showing a normalized line profile obtained from the projection image of Example 1.

FIG. 6 is a diagram showing a normalized line profile obtained from a background image of Example 1.

FIG. 7 is a diagram showing a line profile obtained by subtracting the normalized line profile obtained from the background image of Example 1 from the normalized line profile obtained from the projection image of Example 1.

FIG. 8 is a diagram showing a line profile obtained by smoothing a line profile obtained by subtracting the normalized line profile obtained from the background image of Example 1 from the normalized line profile obtained from the projection image of Example 1.

### MODE FOR CARRYING OUT THE INVENTION

Hereinafter, embodiments of the present invention will be described in detail. The scope of the present invention is not limited to the embodiments described herein, and various modifications can be made without departing from the spirit of the present invention.

The film of the present invention is a cast film containing a resin having a weight average molecular weight of 200,000 or more,

wherein, when line profiles in a direction h and a direction v which are orthogonal to each other in a film inverse space image obtained by Fourier transforming a projection image obtained by a projection method using the cast film are line profiles h and v, respectively;

line profiles in a direction h′ and a direction v′ which are orthogonal to each other in a background inverse space image obtained by Fourier transforming a background image obtained without using the cast film in the projection method are line profiles h′ and v′, respectively;

a maximum intensity of a line profile (h−h′) obtained by subtracting the line profile h′ from the line profile h is Yₘₕ;

a frequency indicating the maximum intensity Yₘₕ is Xₘₕ;

a maximum intensity of a line profile (v−v′) obtained by subtracting the line profile v′ from the line profile v is Yₘᵥ; and

a frequency indicating the maximum intensity Yₘᵥ is Xₘᵥ,

Yₘₕ and Yₘᵥ are both 30 or less, and Yₘₕ, Yₘᵥ, Xₘₕ and Xₘᵥ satisfy the following relationship:

(Yₘₕ+Yₘᵥ)/(Xₘₕ+Xₘᵥ)^{1/2}<20 [Mathematical Formula 2]

Here, the direction h and the direction h′ are directions corresponding to each other, and the direction v and the direction v′ are directions corresponding to each other. The matter that these directions correspond to each other means that these directions are identical in azimuth angle. The film of the present invention satisfying the above characteristics has excellent optical homogeneity, and is particularly preferably used as an optical film in an image display device. Here, the optical homogeneity of the film is closely related to the planar unevenness, thickness unevenness, alignment unevenness, and the like of the film. These unevenness decrease the optical homogeneity. Therefore, it can be said that the film of the present invention having excellent optical homogeneity is a film with decreased unevenness such as planar unevenness, thickness unevenness and alignment unevenness.

The film inverse space image obtained by Fourier transforming a projection image obtained by a projection method using the film of the present invention, and the background inverse space image obtained by Fourier transforming a background image obtained without using the film in the projection method are not particularly limited so long as they can be obtained by Fourier transform from the projection image and the background image, respectively. For example, they can be obtained, for example, by the following steps (1) to (3):

(1) obtaining a projection image by a projection method in which light from a light source is irradiated onto a film and light transmitted through the film is projected onto a projection plane;

(2) projecting light from the light source onto the projection plane without using the film in the projection method of step (1) to obtain a background image;

(3) quantifying each of the projection image obtained in step (1) and the background image obtained in step (2) through gray scale conversion and Fourier transforming the quantified image data to obtain inverse space images (film inverse space image and background inverse space image).

The plane quality of the film is evaluated using the inverse space image, thereby making it possible to analyze the color-shade and period of unevenness.

The method for obtaining the inverse space image through Fourier transform from the projection image by the film projection method is not particularly limited. For example, a method in the following description about the method for evaluating of the present invention may be used.

Next, (4) subtracting line profiles in two directions orthogonal to each other in the inverse space image of the background image from line profiles in the two directions orthogonal to the inverse space image of the projection image to obtain blank-corrected line profiles; and

(5) measuring maximum intensities Yₘₐₓ (Yₘₕ and Yₘᵥ, respectively) of the blank-corrected line profiles obtained in step (4) and frequencies Xₘₐₓ (Xₘₕ and Xₘᵥ) indicating the maximum intensities Yₘₐₓ (Yₘₕ and Yₘᵥ) in each line profile.

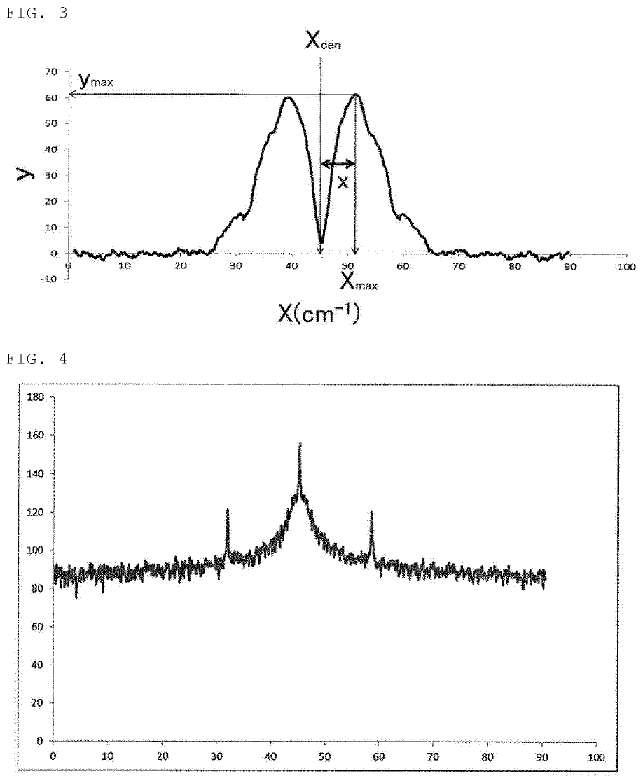

For example, a case where a line profile is created in each of the horizontal direction (h1 direction) and the vertical direction (v1 direction) passing through the center of the inverse space image will be described below. For example, as shown in FIG. 3, the line profile is shown as a graph indicating the frequency on the X axis and the intensity on the Y axis. Then, the maximum intensity Yₘₐₓ in the line profile in the horizontal direction (h1 direction) is defined as Yₘₕ₁, and a value Xₘₐₓ obtained by subtracting a median value X_{cen} of all frequencies in the blank-corrected line profile from a frequency indicating the maximum intensity Yₘₕ₁ is defined as Xₘₕ₁. Further, the maximum intensity Yₘₐₓ in the line profile in the vertical direction (v1 direction) is defined as Yₘᵥ₁, and a value Xₘₐₓ obtained by subtracting the median value X_{cen} of all frequencies in the blank-corrected line profile from a frequency indicating the maximum intensity Yₘᵥ₁ is defined as Xₘᵥ₁.

In the above example, the horizontal direction (h1 direction) and the vertical direction (v1 direction) passing through the center of the space image are selected as two orthogonal directions, but the two directions (h direction and v direction) are not particularly limited, so long as they are orthogonal to each other. The directions may be two directions that do not pass through the center, or may not be the horizontal direction or the vertical direction.

The “blank-corrected line profile” as used herein refers to a line profile obtained by subtracting each of line profiles in the two directions orthogonal to each other in an inverse space image of a background image from each of line profiles in the two directions orthogonal to each other in an inverse space image of a projection image. With the above operation, the baseline of the line profile in the inverse space image of the projection image can be corrected.

In the film of the present invention, Yₘₕ and Yₘᵥ are both 30 or less. When Yₘₕ or Yₘᵥ exceeds 30, the optical homogeneity of the film cannot be said to be sufficient for use as an optical film in an image display device, and image distortion and the like cannot be reduced sufficiently. Yₘₕ and Yₘᵥ are preferably 28 or less, more preferably 26 or less, from the viewpoint of easily improving the optical homogeneity and improving the visibility of the image in an image display device. Yₘₕ and Yₘᵥ are preferably as small as possible, and the lower limit thereof is not particularly limited, may be sufficiently 0 or more, and is usually 1 or more.

In the film of the present invention, Yₘₕ, Yₘᵥ, Xₘₕ and Xₘᵥ obtained as described above satisfy the following relationship:

(Yₘₕ+Yₘᵥ)/(Xₘₕ+Xₘᵥ)^{1/2}<20 [Mathematical Formula 3]

If the (Yₘₕ+Yₘᵥ)/(Xₘₕ+Xₘᵥ)^{1/2} value exceeds 20, the screen will be distorted. From the viewpoint of further improving the optical homogeneity of the film, the above value is preferably 19.5 or less, more preferably 19 or less, even more preferably 18.5 or less, even more preferably 18 or less, particularly preferably 17 or less, and even more particularly preferably 16 or less. A smaller (Yₘₕ+Yₘᵥ) (Xₘₕ+Xₘᵥ)^{1/2} value is better, and the lower limit thereof is not particularly limited, may be 0 or more, and is usually 0.5 or more.

In the film of the present invention, the median value of all frequencies in the blank-corrected line profile obtained as described above is defined as X_{cen}. For example, in the line profile shown in FIG. 3, all frequencies are 90 cm⁻¹, and the median value thereof, 45 cm⁻¹, is X_{cen}. Here, it is preferable that X_{cen} and Xₘₕ and Xₘᵥ obtained as described above satisfy the following relationship.

0.1 cm⁻¹≤|Xₘ−X_{cen}|≤10 cm⁻¹ [Mathematical Formula 4]

In the above formula, Xₘ represents Xₘₕ or Xₘᵥ, and it is preferable that both Xₘₕ and Xₘᵥ satisfy the above formula. The lower limit of |Xₘ−X_{cen}| is more preferably 0.5 cm⁻¹ or more, further preferably 1.0 cm⁻¹ or more. Further, the upper limit of |Xₘ−X_{cen}| is more preferably 8.0 cm⁻¹ or less, further preferably 6.0 cm⁻¹ or less. In consideration of providing the optical homogeneity that is not visually recognized as unevenness and productivity, it is preferable that Xₘₕ and Xₘᵥ satisfy the above relationship.

The elastic modulus of the film of the present invention having the above characteristics is preferably 3 GPa or more, preferably 3.5 GPa or more, from the viewpoint of easily stabilizing the transportability when the film is transported by the roll-to-roll method.

The yellowness of the film of the present invention having the above characteristics is preferably 3 or less, more preferably 2 or less, from the viewpoint of easily improving the optical properties when used as an optical film within an image display element.

The average linear expansion coefficient in the temperature range of 50 to 200° C. of the film of the present invention having the above characteristics is preferably 100 ppm/° C. or less, more preferably 60 ppm/° C. or less. When the average linear expansion coefficient is less than or equal to the above upper limit, curling and wrinkles that may occur when the film is processed tend to be suppressed.

In the film of the present invention having the above characteristics, the total light transmittance conforming to JIS K 7105:1981 is preferably 85% or more, more preferably 90% or more, further preferably 92% or more. When the total light transmittance is equal to or more than the lower limit, sufficient visibility can be ensured when the film is incorporated in an image display device. Therefore, since the film of the present invention has high optical homogeneity and high transmittance, it is possible to suppress the light emission intensity of a display element or the like in order to obtain certain brightness, for example, as compared with the case of using a film with low transmittance. For this reason, power consumption can be reduced.

The film of the present invention is a cast film containing a resin having a weight average molecular weight of 200,000 or more. The cast film refers to, for example, a film obtained by casting and applying, onto a suitable carrier, a solution, dispersion or melt containing the above resin, forming a coating through heating, cooling, drying, etc., and, according to need, peeling the coating from the carrier. The thus-obtained film contains at least a resin having a weight average molecular weight of 200,000 or more and a solvent, for example.

The film of the present invention is not particularly limited as long as it has the above characteristics and excellent optical homogeneity, and the resin contained in the film is not limited as long as it includes a resin having a weight average molecular weight of 200,000 or more. For example, the resin contained in the film may be a thermoplastic resin or a thermosetting resin. Further, the film of the present invention may be a film containing one kind of resin, or a film containing a combination of two or more kinds of resins. For example, examples of the film of the present invention include a polypropylene film, a polyethylene film, a polyimide-based film (more specifically, a polyimide film, a polyamideimide film, and a polyamide film), an acrylic film, and a TAC film. From the viewpoint of achieving both transparency and mechanical strength, the film of the present invention is preferably a polyimide film, a polyamideimide film or a polyamide film. Moreover, the structure of the film is not limited at all, and may be a single layer structure or a laminate of a multilayer structure.

From the viewpoint of easy use of the film of the present invention as an optical film in an image display device, the film of the present invention is preferably a polyimide film, a polyamideimide film, or a polyamide film, more preferably a polyimide film or a polyamideimide film.

In a preferred embodiment of the present invention in which the film is a polyimide-based film, the polyimide-based film contains a polyimide-based polymer. The polyimide-based polymer may be used alone or in combination of two or more. The polyimide-based polymer as used herein means at least one kind of polymer selected from the group consisting of a polymer containing a repeating structural unit containing an imide group, a polymer containing a repeating structural unit containing an amide group, and a polymer containing a repeating structure unit containing both an imide group and an amide group.

The polyimide-based polymer can be manufactured using, for example, a tetracarboxylic acid compound and a diamine compound which will be described later as main raw materials. In one embodiment of the present invention, the polyimide-based polymer has a repeating structural unit represented by Formula (10). In the formula, G is a tetravalent organic group, and A is a divalent organic group. The polyimide-based polymer may include a structure represented by two or more kinds of Formula (10) in which G and/or A are/is different.

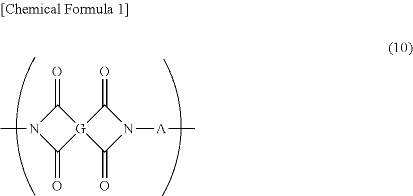

Further, the polyimide-based polymer includes one or more selected from the group consisting of structures represented by Formula (11), Formula (12) and Formula (13) within a range not impairing various physical properties of the polyimide-based film.

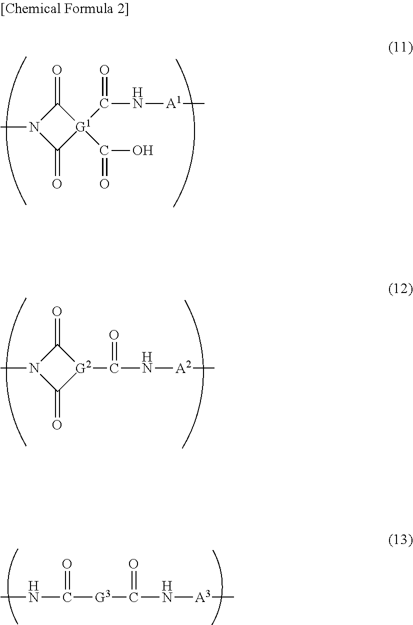

In the Formulas (10) and (11), G and G¹ are each independently a tetravalent organic group, preferably an organic group that may be substituted with a hydrocarbon group or a fluorine-substituted hydrocarbon group. As G and G¹, exemplified are a group represented by Formula (20), Formula (21), Formula (22), Formula (23), Formula (24), Formula (25), Formula (26), Formula (27), Formula (28) or Formula (29) and a tetravalent chain hydrocarbon group having 6 or less carbon atoms. Since it is easy to suppress the yellowness of the resulting film, amongst others, a group represented by Formula (20), Formula (21), Formula (22), Formula (23), Formula (24), Formula (25), Formula (26) or Formula (27) is preferable.

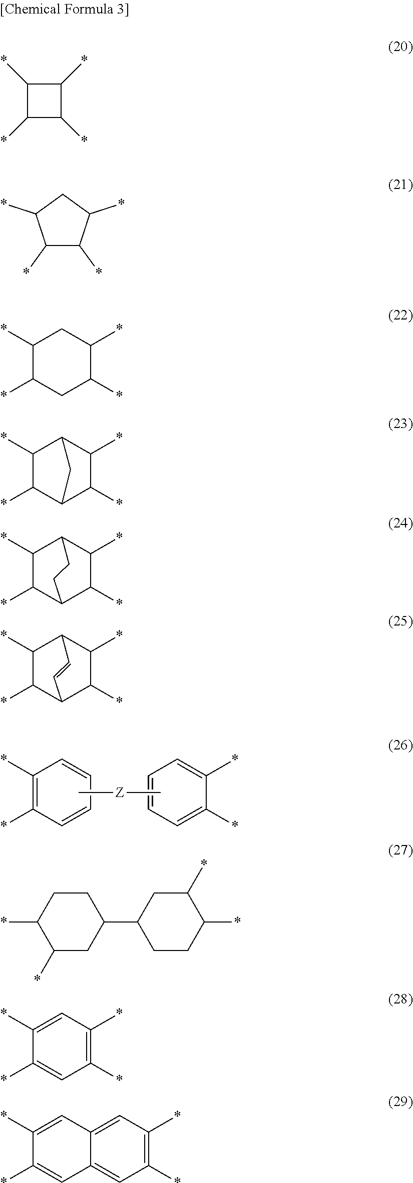

In the Formulas (20) to (29), * represents a bond, and Z represents a single bond, —O—, —CH₂—, —CH₂—CH₂—, —CH(CH₃)—, —C(CH₃)₂—, —C(CF₃)₂—, —Ar—, —SO₂—, —CO—, —O—Ar—O—, —Ar—O—Ar—, —Ar—CH₂—Ar—, —Ar—C(CH₃)₂—Ar— or —Ar—SO₂—Ar—.

Ar represents an arylene group with 6 to 20 carbon atoms which may be substituted with a fluorine atom, and specific examples thereof include a phenylene group.

In the Formula (12), G² is a trivalent organic group, preferably an organic group which may be substituted with a hydrocarbon group or a fluorine-substituted hydrocarbon group. As G², exemplified are a group in which any one of bonds of a group represented by Formula (20), Formula (21), Formula (22), Formula (23), Formula (24), Formula (25), Formula (26), Formula (27), Formula (28) or Formula (29) is replaced with a hydrogen atom, and a trivalent chain hydrocarbon group having 6 or less carbon atoms.

In the Formula (13), G³ is a trivalent organic group, preferably an organic group which may be substituted with a hydrocarbon group or a fluorine-substituted hydrocarbon group. As G³, exemplified are a group in which non-adjacent two of bonds of a group represented by Formula (20), Formula (21), Formula (22), Formula (23), Formula (24), Formula (25), Formula (26), Formula (27), Formula (28) or Formula (29) are replaced with hydrogen atoms, and a chain hydrocarbon group having 6 or less carbon atoms.

In the Formulas (10) to (13), A, A¹, A² and A³ are each independently a divalent organic group, preferably an organic group that may be substituted with a hydrocarbon group or a fluorine-substituted hydrocarbon group. As A, A¹, A² and A³, exemplified are a group represented by Formula (30), Formula (31), Formula (32), Formula (33), Formula (34), Formula (35), Formula (36), Formula (37) or Formula (38); a group in which the group is substituted with a methyl group, a fluoro group, a chloro group or a trifluoromethyl group; and a chain hydrocarbon group having 6 or less carbon atoms.

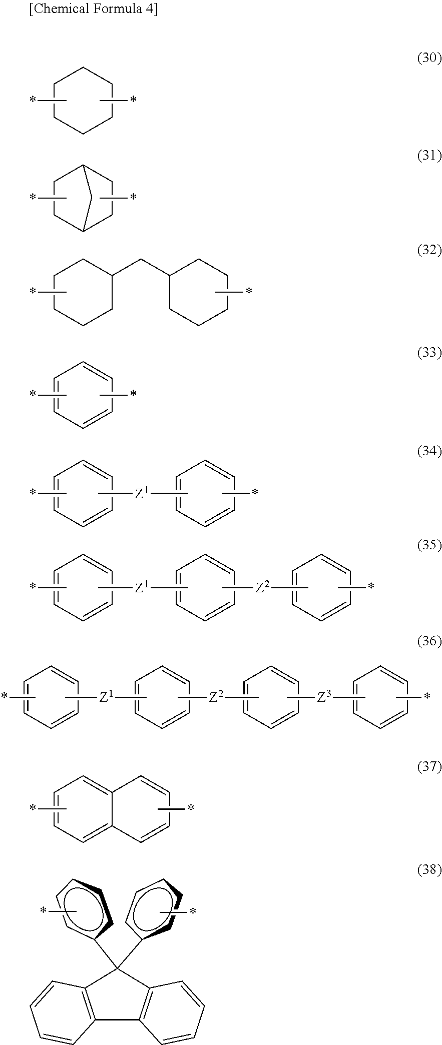

In the Formulas (30) to (38), * represents a bond, and Z¹, Z² and Z³ each independently represent a single bond, —O—, —CH₂—, —CH₂—CH₂—, —CH(CH₃)—, —C(CH₃)₂—, —C(CF₃)₂—, —SO₂— or —CO—.

In one example, Z¹ and Z³ are —O—, and Z² is —CH₂—, —C(CH₃)₂—, —C(CF₃)₂— or —SO₂—. The binding position of Z¹ and Z² with respect to each ring and the binding position of Z² and Z³ with respect to each ring are preferably in a meta position or a para position with respect to each ring.

The polyamide contained in the polyimide-based film of the present invention is a polymer mainly containing a repeating structural unit containing an amide group. The polyamide according to this embodiment is a polymer mainly composed of repeating structural units represented by Formula (13). Preferred examples and specific examples are the same as those for G³ and A³ in the polyimide-based polymer. Two or more kinds of structures represented by Formula (13) in which G³ and/or A³ are/is different may be included.

The polyimide-based polymer can be obtained, for example, by polycondensation of a diamine and a tetracarboxylic acid compound (tetracarboxylic dianhydride or the like). For example, it can be synthesized according to the method described in JP 2006-199945 A or JP 2008-163107 A. Examples of commercially available polyimide-based polymers include Neoprim (registered trademark) manufactured by Mitsubishi Gas Chemical Company, Inc. and KPI-MX300F manufactured by Kawamura Sangyo Co., Ltd.

Examples of tetracarboxylic acid compounds used for synthesis of the polyimide-based polymer include aromatic tetracarboxylic acid compounds such as aromatic tetracarboxylic dianhydrides; and aliphatic tetracarboxylic acid compounds such as aliphatic tetracarboxylic dianhydrides. Tetracarboxylic acid compounds may be used alone or in combination of two or more. The tetracarboxylic acid compound may be a dianhydride or a tetracarboxylic acid compound analog such as an acid chloride compound.

Specific examples of the aromatic tetracarboxylic dianhydride include: 4,4′-oxydiphthalic dianhydride, 3,3′,4,4′-benzophenone tetracarboxylic dianhydride, 2,2′,3,3′-benzophenonetetracarboxylic dianhydride, 3,3′,4,4′-biphenyltetracarboxylic dianhydride, 2,2′,3,3′-biphenyltetracarboxylic dianhydride, 3,3′,4,4′-diphenylsulfonetetracarboxylic dianhydride, 2,2-bis (3,4-dicarboxyphenyl) propane dianhydride, 2,2-bis (2,3-dicarboxyphenyl) propane dianhydride, 2,2-bis (3,4-dicarboxyphenoxyphenyl) propane dianhydride, 4,4′-(hexafluoroisopropylidene) diphthalic dianhydride (6FDA), 1,2-bis (2,3-dicarboxyphenyl) ethane dianhydride, 1,1-bis (2,3-dicarboxyphenyl) ethane dianhydride, 1,2-bis (3,4-dicarboxyphenyl) ethane dianhydride, 1,1-bis (3,4-dicarboxyphenyl) ethane dianhydride, bis (3,4-dicarboxyphenyl) methane dianhydride, bis (2,3-dicarboxyphenyl) methane dianhydride and 4,4′-(p-phenylenedioxy) diphthalic dianhydride and 4,4′-(m-phenylenedioxy) diphthalic dianhydride. These may be used alone or in combination of two or more.

Examples of the aliphatic tetracarboxylic dianhydride include a cyclic or acyclic aliphatic tetracarboxylic dianhydride. The cycloaliphatic tetracarboxylic dianhydride is a tetracarboxylic dianhydride having an alicyclic hydrocarbon structure, and specific examples thereof include 1,2,4,5-cyclohexanetetracarboxylic dianhydride; 1,2,3,4-cycloalkanetetracarboxylic dianhydride such as 1,2,3,4-cyclobutanetetracarboxylic dianhydride and 1,2,3,4-cyclopentanetetracarboxylic dianhydride; bicyclo [2.2.2] oct-7-ene-2,3,5,6-tetracarboxylic dianhydride, dicyclohexyl 3,3′-4,4′-tetracarboxylic dianhydride and their positional isomers. These may be used alone or in combination of two or more. Specific examples of acyclic aliphatic tetracarboxylic dianhydride include 1,2,3,4-butanetetracarboxylic dianhydride and 1,2,3,4-pentanetetracarboxylic dianhydride. These may be used alone or in combination of two or more. Further, a cycloaliphatic tetracarboxylic dianhydride and an acyclic aliphatic tetracarboxylic dianhydride may be used in combination.

Among the above tetracarboxylic dianhydrides, 1,2,4,5-cyclohexanetetracarboxylic dianhydride, bicyclo [2.2.2] oct-7-ene-2,3,5,6-tetracarboxylic dianhydride and 4,4′-(hexafluoroisopropylidene) diphthalic dianhydride, and mixtures thereof are preferred from the viewpoint of high transparency and low colorability.

In addition, the polyimide-based polymer according to the present embodiment may include those obtained by further reacting tetracarboxylic acid, tricarboxylic acid and dicarboxylic acid, and anhydrides and derivatives thereof, in addition to the tetracarboxylic acid anhydride used in the above polyimide synthesis within a range not impairing various physical properties of the polyimide-based film.

Examples of the tetracarboxylic acid include water adducts of anhydrides of the above tetracarboxylic acid compounds.

Examples of the tricarboxylic acid compound include aromatic tricarboxylic acids, aliphatic tricarboxylic acids, and analogous acid chloride compounds, and acid anhydrides, and two or more of them may be used in combination.

Specific examples include 1,2,4-benzenetricarboxylic acid anhydride; 2,3,6-naphthalenetricarboxylic acid-2,3-anhydride; and a compound in which phthalic anhydride and benzoic acid are linked by a single bond, —CH₂—, —C(CH₃)₂—, —C(CF₃)₂—, —SO₂— or a phenylene group.

Examples of the dicarboxylic acid compound include aromatic dicarboxylic acids, aliphatic dicarboxylic acids, and analogous acid chloride compounds, and acid anhydrides, and two or more of them may be used in combination.

Specific examples of those compounds include terephthalic acid dichloride; isophthalic acid dichloride; naphthalenedicarboxylic acid dichloride; 4,4′-biphenyldicarboxylic acid dichloride; 3,3′-biphenyldicarboxylic acid dichloride; 4,4′-oxybis (benzoyl chloride) (OBBC); a chain hydrocarbon dicarboxylic acid compound having 8 or less carbon atoms; and a compound in which two benzoic acids are linked by a single bond, —CH₂—, —C(CH₃)₂—, —C(CF₃)₂—, —SO₂— or a phenylene group.

Examples of the diamine used for the synthesis of the polyimide-based polymer include aliphatic diamines, aromatic diamines, and mixtures thereof. In the present embodiment, the “aromatic diamine” refers to a diamine in which an amino group is directly bonded to an aromatic ring, and an aliphatic group or any other substituent may be included in a part of the structure. The aromatic ring may be a single ring or a condensed ring, and examples thereof include, but are not limited to, a benzene ring, a naphthalene ring, an anthracene ring, and a fluorene ring. Among these, the aromatic ring is preferably a benzene ring. The “aliphatic diamine” refers to a diamine in which an amino group is directly bonded to an aliphatic group, and an aromatic ring or any other substituent may be included in a part of the structure.

Examples of the aliphatic diamine include acyclic aliphatic diamines such as hexamethylene diamine, 1,3-bis (aminomethyl) cyclohexane, 1,4-bis (aminomethyl) cyclohexane, norbornane diamine, and cycloaliphatic diamines such as 4,4′-diaminodicyclohexylmethane. These may be used alone or in combination of two or more.

Examples of the aromatic diamine include aromatic diamine having one aromatic ring, such asp-phenylenediamine, m-phenylenediamine, 2,4-toluenediamine, m-xylylenediamine, p-xylylenediamine, 1,5-diaminonaphthalene, and 2,6-diaminonaphthalene; and aromatic diamines having two or more aromatic rings such as 4,4′-diaminodiphenylmethane, 4,4′-diaminodiphenylpropane, 4,4′-diaminodiphenyl ether, 3,4′-diaminodiphenyl ether, 3,3′-diaminodiphenyl ether, 4,4′-diaminodiphenyl sulfone, 3,4′-diaminodiphenyl sulfone, 3,3′-diaminodiphenyl sulfone, 1,4-bis (4-aminophenoxy) benzene, 1,3-bis (4-aminophenoxy) benzene, 4,4′-diaminodiphenylsulfone, bis [4-(4-aminophenoxy) phenyl] sulfone, bis [4-(3-aminophenoxy) phenyl] sulfone, 2,2-biphenyl [4-(4-aminophenoxy) phenyl] propane, 2,2-bis [4-(3-aminophenoxy) phenyl] propane, 2,2′-dimethylbenzidine, 2,2′-bis (trifluoromethyl) benzidine (2,2′-bis (trifluoromethyl)-4,4′-diaminodiphenyl (TFMB)), 4,4′-bis (4-aminophenoxy) biphenyl, 4,4′-diaminodiphenyl ether, 3,4′-diaminodiphenyl ether, 4,4′-diaminodiphenylmethane, 9,9-bis (4-aminophenyl) fluorene, 9,9-bis (4-amino-3-methylphenyl) fluorene, 9,9-bis (4-amino-3-chlorophenyl) fluorene and 9,9-bis (4-amino-3-fluorophenyl) fluorene. These may be used alone or in combination of two or more.

Among the diamines, from the viewpoint of high transparency and low colorability, it is preferable to use one or more selected from the group consisting of aromatic diamines having a biphenyl structure. One or more selected from the group consisting of 2,2′-dimethylbenzidine, 2,2′-bis (trifluoromethyl) benzidine, 4,4′-bis (4-aminophenoxy) biphenyl and 4,4′-diaminodiphenyl ether are more preferably used, and 2,2′-bis (trifluoromethyl) benzidine is further more preferably used.

The polyimide-based polymer and polyamide which are polymers containing at least one repeating structural unit represented by Formula (10), Formula (11), Formula (12) or Formula (13) are polycondensation polymers which are polycondensation products of a diamine with at least one compound included in the group consisting of tetracarboxylic acid compounds (tetracarboxylic acid compound analogues such as acid chloride compounds and tetracarboxylic dianhydrides), tricarboxylic acid compounds (tricarboxylic acid compound analogues such as acid chloride compounds and tricarboxylic anhydrides) and dicarboxylic acid compounds (dicarboxylic acid compound analogues such as acid chloride compounds). As starting materials, in addition to these, dicarboxylic acid compounds (including analogs such as acid chloride compounds) may be used. The repeating structural unit represented by Formula (11) is normally derived from a diamine and a tetracarboxylic acid compound. The repeating structural unit represented by Formula (12) is usually derived from a diamine and a tricarboxylic acid compound. The repeating structural unit represented by Formula (13) is usually derived from a diamine and a dicarboxylic acid compound. Specific examples of the diamine and the tetracarboxylic acid compound are as described above.

The weight average molecular weight of the polyimide-based polymer is 200,000 or more, preferably 200,000 to 500,000, more preferably 200,000 to 450,000, further preferably 250,000 to 400,000. As the weight average molecular weight of the polyimide-based polymer is larger, there is a tendency that high bending resistance is more easily exhibited when it is formed into a film. Therefore, from the viewpoint of easily improving the bending resistance of the film, the weight average molecular weight is preferably not less than the above lower limit. On the other hand, as the weight average molecular weight of the polyimide-based polymer is smaller, there is a tendency that the viscosity of the varnish is easily lowered and that the workability is easily improved. Moreover, there is a tendency that the stretchability of the polyimide-based film is easily improved. Therefore, from the viewpoint of processability and stretchability, the weight average molecular weight is preferably not more than the above upper limit. In the present application, the weight average molecular weight can be determined through standard polystyrene conversion by GPC measurement. From the above viewpoint, the weight average molecular weight of the polyimide-based polymer contained in the varnish is preferably within the above range.

The imidization rate of the polyimide-based polymer is preferably 95 to 100%, more preferably 97 to 100%, still more preferably 98 to 100%, particularly preferably 100%.

From the viewpoint of the stability of the varnish and the mechanical properties of the obtained film, it is preferable that the imidization rate is not less than the above lower limit. The imidization rate can be determined by IR method, NMR method, or the like. From the above viewpoint, it is preferable that the imidization rate of the polyimide-based polymer contained in the varnish is within the above range.

In a preferred embodiment of the present invention, the polyimide-based polymer and polyamide contained in the polyimide-based film of the present invention may contain a halogen atom such as a fluorine atom, which can be introduced, for example, by the fluorine-containing substituent described above. When the polyimide-based polymer and polyamide contain a halogen atom, it is easy to improve the elastic modulus of the polyimide-based film and to reduce the yellowness (YI value). When the elastic modulus of the polyimide-based film is high, generation of scratches and wrinkles in the polyimide-based film is easily suppressed. When the yellowness of the polyimide-based film is low, the transparency of the film is easily improved. The halogen atom is preferably a fluorine atom. Preferred fluorine-containing substituents for incorporating a fluorine atom into the polyimide-based polymer and polyamide include, for example, a fluoro group and a trifluoromethyl group.

The content of the halogen atom in the polyimide-based polymer or polyamide is preferably 1 to 40% by mass, more preferably 5 to 40% by mass, still more preferably 5 to 30% by mass based on the mass of the polyimide-based polymer or polyamide. When the halogen atom content is 1% by mass or more, it is easy to further improve the elastic modulus when the polyimide-based polymer or polyamide is formed into a film, to lower the water absorption, to further reduce the YI value, and to further improve the transparency. If the halogen atom content exceeds 40% by mass, synthesis may be difficult.

In one embodiment of the present invention, the polyimide-based polymer can be produced by a polycondensation reaction between a diamine and a tetracarboxylic acid compound. In this polycondensation reaction, an imidization catalyst may be present. Examples of imidization catalysts include aliphatic amines such as tripropylamine, dibutylpropylamine, and ethyldibutylamine; alicyclic amines (monocyclic) such as N-ethylpiperidine, N-propylpiperidine, N-butylpyrrolidine, N-butylpiperidine, and N-propylhexahydro azepine; alicyclic amines (polycyclic) such as azabicyclo [2.2.1] heptane, azabicyclo [3.2.1] octane, azabicyclo [2.2.2] octane, and azabicyclo [3.2.2] nonane; and aromatic amines such as 2-methylpyridine, 3-methylpyridine, 4-methylpyridine, 2-ethylpyridine, 3-ethylpyridine, 4-ethylpyridine, 2,4-dimethylpyridine, 2,4,6-trimethylpyridine, 3,4-cyclopentenopyridine, 5,6,7,8-tetrahydroisoquinoline, and isoquinoline.

The temperature of the reaction between a diamine and a tetracarboxylic acid compound is not particularly limited, and is, for example, 50 to 350° C. The reaction time is not particularly limited, and is, for example, about 30 minutes to 10 hours. If necessary, the reaction may be carried out under an inert atmosphere or under reduced pressure. The reaction may be performed in a solvent, and examples of the solvent include the following solvents used for the preparation of polyimide-based varnishes (more specifically, polyimide varnish, polyamideimide varnish, and polyamide varnish).

In one embodiment of the present invention, the content of the polyimide-based polymer in the polyimide-based film is preferably 40% by mass or more, more preferably 50% by mass or more, further preferably 70% by mass or more based on the total mass of the polyimide-based film. The content of the polyimide-based polymer is preferably equal to or more than the above lower limit from the viewpoint of easily improving the flexibility. The content of the polyimide-based polymer in the polyimide-based film is usually 100% by mass or less based on the total mass of the polyimide-based film.

The film of the present invention having the above characteristics can be manufactured by a manufacture method including at least the step of applying a varnish containing at least a resin and a solvent to a support, and the step of drying the varnish coating to obtain a film. Here, the viscosity (cps) of the varnish and the resin concentration (% by mass) of the varnish satisfy the following relationship, and the film thickness distribution of the support is ±3 μm or less. The present invention also provides a method for manufacturing the film.

Viscosity of varnish×resin concentration of varnish>4000 [Mathematical Formula 5]

First, the step of applying a varnish containing at least a resin and a solvent to a support will be described. Examples of the resin contained in the varnish include the resins described above as the resin contained in the film of the present invention. From the viewpoint of obtaining the above preferred film, the resin contained in the varnish is preferably a polyimide-based polymer, a polyamideimide-based polymer, and/or a polyamide-based polymer.

The solvent contained in the varnish should just be a solvent which can dissolve the above resin, and should just be selected suitably according to resin to be used. Examples of the solvent include amide-based solvents, lactone-based solvents, sulfur-containing solvents, and carbonate-based solvents. As the solvent, one kind of solvent may be used, or two or more kinds of solvents may be mixed and used. For example, when the resin is a polyimide-based polymer, examples of usable solvents include amide-based solvents such as N,N-dimethylformamide and N,N-dimethylacetamide; lactone-based solvents such as γ-butyrolactone and γ-valerolactone; sulfur-containing solvents such as dimethyl sulfone, dimethyl sulfoxide and sulfolane; and carbonate-based solvents such as ethylene carbonate and propylene carbonate. Among these solvents, amide-based solvents or lactone-based solvents are preferable.

Examples of other additives that can be contained in the varnish in addition to the resin and the solvent include leveling agents, antioxidants, ultraviolet absorbers, bluing agents, plasticizers, and surfactants.

The varnish can be prepared by mixing and stirring the resin, the solvent and other additives used as necessary. For example, when the resin is a polyimide-based polymer, the varnish may be prepared by mixing a reaction solution of a polyimide-based polymer obtained by reacting those selected from the tetracarboxylic acid compounds, the diamines and the other raw materials with a solvent and optionally other additives and stirring the mixture. Instead of the reaction solution of the polyimide-based polymer, a solution of a purchased polyimide-based polymer or a solution of a purchased solid polyimide-based polymer may be used.

The viscosity (cps) of the varnish prepared as described above and the resin concentration (% by mass) of the varnish are not particularly limited, but, from the viewpoint of easily obtaining the film of the present invention having excellent optical homogeneity, it is preferable that they satisfy the following relationship.

Viscosity of varnish×resin concentration of varnish>4000 [Mathematical Formula 6]

Here, the viscosity (cps) of the varnish is measured at 25° C. using an E-type viscometer in conformity with JIS K8803:2011. The resin concentration of the varnish represents the concentration (% by mass) of the resin contained in the varnish, and is calculated from the mass of the resin contained in the varnish based on the total mass of the varnish. The product of the viscosity of the varnish represented by the above formula and the resin concentration of the varnish is preferably 4,000 or more, more preferably 5,000 or more, from the viewpoint of easily improving the optical homogeneity of the film. The upper limit of the product of the viscosity of the varnish represented by the above formula and the resin concentration of the varnish is not particularly limited, but is preferably 10,000 or less, more preferably 7,000 or less from the viewpoint of handling of the varnish.

The viscosity of the varnish is preferably 5,000 to 60,000 cps, more preferably 10,000 to 50,000 cps, still more preferably 15,000 to 45,000 cps. When the viscosity of the varnish is not less than the above lower limit, the effects of the present invention can be easily obtained. It is preferably that the viscosity of the varnish be not more than the above lower limit, from the viewpoint of easy handling of the varnish.

The resin concentration of the varnish is preferably 5 to 25% by mass, more preferably 10 to 23% by mass, further preferably 14 to 20% by mass. The resin concentration of the varnish is preferably not less than the above lower limit from the viewpoint of obtaining a thick film thickness, and is preferably not more than the above upper limit from the viewpoint of easy handling of the varnish.

Examples of the support include a resin base material, a stainless steel belt, and a glass base material. It is preferable to use a resin film substrate as the support. Examples of the resin film substrate include a polyethylene terephthalate (PET) film, a polyethylene naphthalate (PEN) film, a cycloolefin-based (COP) film, an acrylic film, a polyimide film, and a polyamideimide film.

The film thickness of the support is not particularly limited, but is preferably 50 to 250 μm, more preferably 100 to 200 μm, still more preferably 150 to 200 μm. The film thickness of the support is preferably not more than the above upper limit, because the cost for manufacturing the film is easily suppressed. Moreover, it is preferable that the film thickness of the support be not less than the above lower limit because curling of the film that may occur in the step of removing at least a part of the solvent is easily suppressed. Here, the film thickness of the support is measured by a contact-type film thickness meter or the like. From the viewpoint of improving the plane quality of the film and facilitating the manufacture of the film of the present invention, the thickness distribution of the support is preferably ±3 μm or less, more preferably ±2.5 μm or less, even more preferably ±2 μm or less. The film thickness distribution of the support is determined as follows: measuring the film thickness at at least 20 locations of the film, calculating the average of the film thicknesses at the 20 locations, and calculating the film thickness distribution from a difference between the film thickness at each location and the average film thickness according to the above-described film thickness measurement method.

When applying the varnish to the support, a known roll-to-roll or batch method may be employed.

Next, the step of drying the varnish coating to obtain a film will be described. The coating is usually dried by evaporating at least a part of the solvent contained in the coating at a temperature of 50 to 350° C., in the air, under an inert atmosphere, or under reduced pressure. The drying time is not particularly limited and may be appropriately determined. Drying may be promoted using hot air or the like. The film of the present invention can be obtained by peeling the film formed on the support by drying from the support. Further drying may be performed after peeling the film. Further drying (post-bake) may usually be carried out by evaporating at least a part of the solvent contained in the coating under conditions: at a temperature of 50 to 350° C., in the air, in an inert atmosphere, or under reduced pressure.

The film thickness of the thus-obtained film is appropriately determined depending on the use of the transparent resin film, etc., and is usually 10 to 500 μm, preferably 15 to 200 μm, more preferably 20 to 100 μm, further preferably 25 to 85 μm. When the film thickness is in the above range, the flexibility of the film is good.

The present invention also provides a method for evaluating the optical homogeneity of a film. According to the evaluation method of the present invention, it is possible to evaluate the optical homogeneity of the film with higher accuracy than in conventional evaluation methods. Specifically, according to the evaluation method of the present invention, it is possible to evaluate the optical homogeneity caused by unevenness in both the TD direction and the MD direction, unevenness in width, etc., which could not be evaluated with sufficient accuracy by conventional evaluation methods, and to accurately evaluate the optical homogeneity of the film regardless of the type of unevenness. Further, according to the evaluation method of the present invention, the optical homogeneity of the film can be quantified. Specifically, the evaluation method of the present invention includes at least the following steps (1) to (5):

(1) obtaining a projection image by a projection method in which light from a light source is irradiated onto a film and light transmitted through the film is projected onto a projection plane;

(2) projecting light from a light source onto a projection plane without using a film in the projection method of step (1) to obtain a background image;

(3) quantifying each of the projection image obtained in step (1) and the background image obtained in step (2) through gray scale conversion and Fourier transforming the quantified image data to obtain inverse space images (film inverse space image and background inverse space image);

(4) subtracting line profiles in two directions orthogonal to each other in the inverse space image of the background image from line profiles in the two directions orthogonal to the inverse space image of the projection image to obtain blank-corrected line profiles; and

(5) measuring the maximum intensities (Yₘₕ and Yₘᵥ) of the blank-corrected line profiles obtained in step (4).

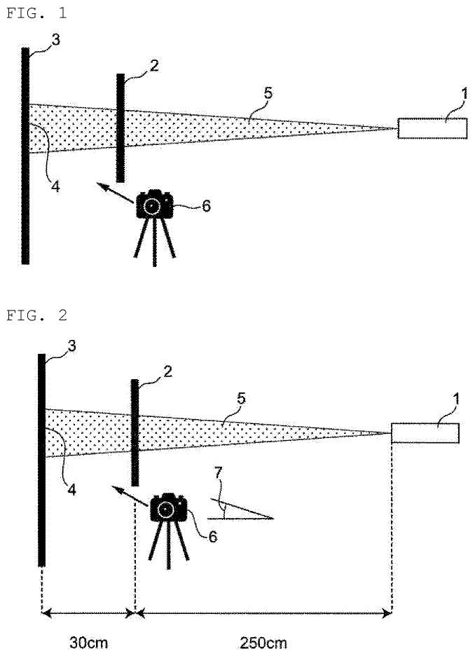

In step (1), a projection image is obtained by irradiating light from a light source onto a film and projecting light transmitted through the film onto a projection plane. In step (1), for example, as shown in FIG. 1, the film, the projection plane, and the like may be arranged. Specifically, a light source 1, a film 2, and a projection plane 3 are arranged, and a projection image 4 projected on the projection plane 3 is taken by a camera 6 to obtain a projection image. Light 5 output from the light source 1 is transmitted through the film 2, and the transmitted light is projected on the projection plane 3 as the projection image 4. When the light 5 is transmitted through the film 2, if the film 2 is homogeneous, the light 5 is transmitted uniformly through the film 2 and reaches the projection plane 3. However, when the film 2 is not homogeneous with planar unevenness, thickness unevenness, alignment unevenness, the light 5 is reflected and/or refracted when being transmitted through the film 2, so that the light in a distorted state reaches the projection plane 3 as compared with the state where light is output from the light source. By evaluating the thus-obtained projection image 4 by the method which will be described later, the optical homogeneity of the film can be evaluated or quantified with high accuracy. From the viewpoint of easily obtaining a clear projection image, it is preferable to take a picture in a dark room while allowing only light from the light source to be transmitted through the film. The type of light source is not particularly limited, and for example, an LED light source or a halogen lamp may be used. A light source close to a point light source is preferable, and the light emitting part preferably has a diameter of 1 cm or less. Since the projection image tends to become unclear when light passes through a filter or lens, light that does not pass through the filter or lens is preferable. The projection plane is not particularly limited as long as the projection image of the film is visually recognized. For example, an acrylic plate, a vinyl chloride plate, a polyethylene plate, a movie screen, or the like may be used. The method for capturing the image projected on the projection plane is not particularly limited. For example, as shown in FIG. 1, the projection plane 3, the film 2, and the light source 1 are arranged in a straight line, and the camera 6 may be fixed at a position where the projection image 4 projected on the projection plane 3 is photographed from an oblique direction. The photographing mode may be set as appropriate, for example, a setting as described in the Examples may be used. In this way, a projection image is obtained.

In step (2), light from the light source is projected onto the projection plane without using the film in the projection method of step (1) to obtain a projection image. Specifically, for example, in FIG. 1, photographing is performed with only the film 2 removed to obtain a background image.

In step (3), each of the projection image obtained in step (1) and the background image obtained in step (2) is quantified through gray scale conversion, and the quantified image data is Fourier transformed to obtain inverse space images. Gray scale conversion can be performed through, for example, 8-bit gray scale conversion using image analysis software (for example, “Image-J” manufactured by National Institutes of Health, USA). The projection image and the background image can be quantified by gray scale conversion. Next, the quantified image data is Fourier transformed to obtain inverse space images (film inverse space image and background inverse space image). By Fourier transforming the quantified image data, it is possible to obtain the period and amplitude of the color-shade of the image. Examples of the Fourier transform method include use of the Fourier transform function of the image analysis software (Image-J).

In step (4), line profiles in two directions orthogonal to each other in the inverse space image of the background image are subtracted from line profiles in the two directions orthogonal to the inverse space image of the projection image to obtain blank-corrected line profiles.

In step (5), measured are the maximum intensities Yₘₐₓ (Yₘₕ and Yₘᵥ, respectively) of the blank-corrected line profiles obtained in step (4). The method for measuring Yₘₕ and Yₘᵥ is as described above for the film of the present invention. For example, when the line profile for each of the horizontal direction (h1 direction) and the vertical direction (v1 direction) passing through the center of the inverse space image is created, the line profile is shown as a graph indicating the frequency on the X axis and the intensity on the Y axis, for example, as shown in FIG. 3. Then, the maximum intensity Yₘₐₓ in the line profile in the horizontal direction (h1 direction) is defined as Yₘₕ₁, and a value Xₘₐₓ obtained by subtracting a median value X_{cen} of all frequencies in the blank-corrected line profile from a frequency indicating the maximum intensity Yₘₕ₁ is defined as Xₘₕ₁. Further, the maximum intensity Yₘₐₓ in the line profile in the vertical direction (v1 direction) is defined as Yₘᵥ₁, and a value Xₘₐₓ obtained by subtracting the median value X_{cen} of all frequencies in the blank-corrected line profile from a frequency indicating the maximum intensity Yₘᵥ₁ is defined as Xₘᵥ₁. The two directions are not particularly limited as long as they are orthogonal to each other, and may be two directions that do not pass through the center, or may not be the horizontal direction or the vertical direction.

According to the evaluation method of the present invention, the optical homogeneity can be evaluated in the two-dimensional direction of the film by measuring the above Yₘₕ and Yₘᵥ. The planar unevenness that contributes to reduction of the optical homogeneity of the film includes a kind of unevenness that cannot be sufficiently detected by one-dimensional evaluation, such as striped unevenness. According to the evaluation method of the present invention, the optical homogeneity can be evaluated in the two-dimensional direction, and therefore, evaluation can be performed with high accuracy regardless of the type of film unevenness. It is also possible to quantify the optical homogeneity of the film by measuring the above Yₘₕ and Yₘᵥ to obtain values thereof.

Furthermore, in addition to the maximum intensities Yₘₕ and Yₘᵥ, evaluation is performed using Xₘₕ and Xₘᵥ, which are values obtained by subtracting the median X_{cen} of all frequencies in the blank-corrected line profiles from the frequencies indicating these maximum intensities, thereby making it possible also to detect the period in which planar unevenness as a cause of influencing the optical homogeneity of the film occurs.

The present invention also provides a method for manufacturing a film, comprising at least the steps of:

applying a varnish containing at least a resin and a solvent to a support;

drying the varnish coating to obtain a film, and

evaluating the film using the evaluation method according to the present invention. Regarding the step of applying the varnish to the support and the step of drying the varnish coating to obtain a film, the above description regarding the method for manufacturing the film of the present invention applies similarly. Concerning the step of evaluating the film using the evaluation method of the present invention, the above description regarding the method for manufacturing the film of the present invention applies similarly. According to the film manufacturing method including such an evaluation method, the optical homogeneity of the film can be evaluated with high accuracy, and therefore a film excellent in optical homogeneity can be efficiently manufactured.

In the step of evaluating the film, it is preferable to evaluate the optical homogeneity of the film based on the maximum strengths Yₘₕ and Yₘᵥ measured by the evaluation method of the present invention and to determine the quality of the film, from the viewpoint of efficiently manufacturing a film excellent in homogeneity. The criteria for determining the quality of the film may be appropriately set according to the intended use of the manufactured film and the optical homogeneity required of the film, and is not particularly limited. When determining the quality of the film for the purpose of obtaining a film having excellent optical homogeneity, which is preferably used in an optical film, etc, it is preferable to determine the quality of the film based on whether the film of the present invention has the characteristics described above.

The intended use of the film of the present invention and the film manufactured by the manufacture method of the present invention is not particularly limited, and they may be used for various applications. As described above, the film of the present invention may be a single layer or a laminate. The film of the present invention may be used as it is or as a laminate with another film. The film of the present invention has excellent plane quality, and thus is useful as an optical film in image display devices and the like.

The film of the present invention is useful as a front plate of an image display device, particularly as a front plate (window film) of a flexible display. The flexible display has, for example, a flexible functional layer and the polyimide-based film that is stacked on the flexible functional layer and functions as a front plate. That is, the front plate of the flexible display is arranged on the visual recognition side on the flexible functional layer. This front plate has a function of protecting the flexible functional layer.

Examples of the image display device include a television, a smartphone, a mobile phone, a car navigation system, a tablet PC, a portable game machine, an electronic paper, an indicator, a bulletin board, a clock, and a wearable device such as a smart watch. The flexible display includes all image display devices having flexible characteristics.

Such an image display device, particularly a flexible display, can be advantageously used as a television, a smartphone, a mobile phone, a car navigation system, a tablet PC, a portable game machine, an electronic paper, an indicator, a bulletin board, a clock, and a wearable device such as a smart watch. This image display device has flexible characteristics and at the same time has a yellowness YI within a predetermined range. Therefore, for example, when used as a front plate material of a flexible display having a bezel part on which white printing has been performed, the image display device is highly visible.

### EXAMPLES

Hereinafter, the present invention will be described in more detail with reference to Examples. In the examples, “%” and “part” mean mass % and part by mass, unless otherwise specified. First, the evaluation method will be described.

(Weight Average Molecular Weight)

Gel Permeation Chromatography (GPC) Measurement

(1) Pretreatment Method

A sample was dissolved in γ-butyrolactone (GBL) to give a 20% by mass solution. The solution was diluted 100 times with a DMF eluent, and filtered through a 0.45 μm membrane filter to obtain a measurement solution.

(2) Measurement Conditions

Column: TSKgel SuperAWM-H×2+SuperAW2500×1 (6.0 mm I.D.×150 mm×3)

Eluent: DMF (10 mM lithium bromide added)

Flow rate: 0.6 mL/min.

Detector: RI detector

Column temperature: 40° C.

Injection volume: 20 μL

Molecular weight standard: standard polystyrene

(Imidization Rate)

The imidization rate was determined by ¹H-NMR measurement as follows.

(1) Pretreatment Method

A sample was dissolved in deuterated dimethyl sulfoxide (DMSO-d₆) to give a 2% by mass solution, which was used as a measurement solution.

(2) Measurement Conditions

Measuring device: JEOL 400 MHz NMR device JNM-ECZ400S/L1

Standard material: DMSO-d₆ (2.5 ppm)

Sample temperature: room temperature

Integration frequency: 256 times

Relaxation time: 5 seconds

(3) Imidization Rate Analysis Method

In the obtained ¹H-NMR spectrum, benzene protons were observed at 7.0 to 9.0 ppm. Among these, the integral ratio of benzene protons A derived from a structure that did not change before and after imidization was defined as Int_{A}. Further, amide protons having an amic acid structure remaining in the polyimide were observed at 10.5 to 11.5 ppm, and this integration ratio was defined as Int_{B}. From these integration ratios, the imidization rate was determined by the following formula.

Imidization rate (%)=100×(1−α×Int_{B}/Int_{A}) [Mathematical Formula 7]

In the above formula, a is the proportion of the number of benzene protons A to one amide proton in the case of polyamic acid (imidization rate 0%).

(Viscosity of Varnish)

In conformity with JIS K8803:2011, the viscosity was measured using an E-type viscometer DV-II+Pro manufactured by Brookfield. The measurement temperature was 25° C.

(Film Thickness and Film Thickness Distribution of Support)

Using ID-C112XBS manufactured by Mitutoyo Corporation, the film thicknesses at 20 points or more in the width direction of the support were measured, a difference between the average value and each data was calculated to obtain the film thickness distribution.

(Film Thickness)

Using ID-C112XBS manufactured by Mitutoyo Corporation, film thicknesses at 10 or more points were measured to calculate the average value.

(Total Light Transmittance of Film)

The total light transmittance of the film was measured with fully automatic direct reading haze computer HGM-2DP manufactured by Suga Test Instruments Co., Ltd. in conformity with JIS K7105:1981.

(Haze of Film)

The total light transmittance of the film was measured with fully automatic direct reading haze computer HGM-2DP manufactured by Suga Test Instruments Co., Ltd. in conformity with JIS K7105:1981.

(Method for Evaluating Optical Homogeneity of Film)

1. Taking of Projection Image and Background Image

The light source 1, the film 2, the projection plane 3, and the camera 6 were arranged in the dark room as shown in FIG. 2 to take the projection image 4. The distance between the light source 1 and the film 2 was 250 cm, the distance between the film 2 and the projection plane 3 was 30 cm, the film 2 and the projection plane 3 were arranged in parallel, and the camera 6 was installed directly below the normal line from the light source 1 to the screen. The distance between the camera 6 and the projection plane 3 (screen) was 30 cm, and the camera angle 7 (angle at which the camera was inclined upward from the state where the camera is oriented perpendicular to the screen) was 25°. The background image was taken in the same manner as the projection image except that the film 2 was removed in FIG. 2. Details of measurement conditions and photographing conditions are shown below.

Light source: LED light source (“LA-HDF15T” manufactured by Hayashi Tokei Kogyo, Co., Ltd.)

Film: A film obtained by cutting out the film manufactured in each of the following Examples and Comparative Examples into 200 mm×300 mm was used as a measurement sample.

Projection plane: White commercial movie screen (“BTP600FHD-SH1000”, manufactured by Theaterhouse)

Camera: “COOLPIX (registered trademark) P600” manufactured by Nikon Corporation

Detailed camera setting: photographing mode Manual photographing

Image size 2M

Focus Manual focus (distance 0.3 m)

Shutter speed ½ second

Aperture value (F value) 4.2

Flash off

2. Fourier Transform

In the present Example, since the camera is installed at the position of the camera angle, the projection image is inclined. Therefore, in order to correct the inclination of the projection image, the inclination correction conditions were first determined.

If there is no distortion of the projection image, no correction is necessary.

(Determination of Inclination Correction Conditions)

A 10 cm×10 cm square was written on a transparent film, and a reference projection image was taken under the conditions presented in the above 1. The obtained reference projection image was read by Photoshop (registered trademark) CS4 manufactured by Adobe Systems Incorporated, and corrected using the distortion correction function of lens correction so that the angle between the camera and the screen corresponded to 90°. The corrected image was saved in the TIFF format. The conditions at this time were set as inclination correction conditions. From the reference projection image after the inclination correction, the lengths per vertical and horizontal pixels were calculated (vertical: 816 pixels=10 cm, horizontal: 906 pixels=10 cm).

(Fourier Transform)

The projection images obtained as described above for the films of Examples and Comparative Examples were corrected under the inclination correction conditions determined as described above, and the corrected images were stored in TIFF format. The obtained projection images after inclination correction were quantified by conversion into 8-bit gray scale using image analysis software “Image-J, ver.1.48”. In addition, the lengths per vertical and horizontal pixels obtained from the reference projection images after inclination correction were used as Set Scale. A rectangular range having a size of 10.2 cm×11.2 cm (vertical×horizontal) in the gray scale image was selected, and the image in the selected range was Fourier transformed using Image-J to obtain an inverse space image. The correct values (horizontal direction: 1 pixel=11.3 cm⁻¹, vertical direction: 1 pixel=12.55 cm⁻¹) were input into Set Scale for the inverse space image after Fourier transform.

3. Measurement of the Maximum Intensity (Yₘₕ₁ and Yₘᵥ₁) of Blank Corrected Line Profile

In the inverse space image obtained as described above, a line profile was created in each of the horizontal direction (h1 direction) and the vertical direction (v1 direction) passing through the center of the inverse space image.

The line width was 10 pixels. The obtained line profile was saved in text format. Next, the text format data was read by Microsoft Excel (ver.14.0), the line profile was normalized as follows to obtain a line profile of Y″ for each of the horizontal direction (h1 direction) and the vertical direction (v1 direction). In each line profile, the maximum intensities Yₘₐₓ were defined as Yₘₕ₁ and Yₘᵥ₁. The values Xₘₐₓ obtained by subtracting the median value X_{cen} of all frequencies in the blank-corrected line profiles from frequencies indicating the maximum intensities Yₘₕ₁ and Yₘᵥ₁ were defined as Xₘₕ₁ and Xₘᵥ₁, respectively. The normalization method will be described using the line profile in the horizontal (h1 direction) obtained in Example 1 as an example.

### [Normalization Method]

The frequency at which the value of Y is maximum is defined as the center of X (X_{cen}), and the value of Y at that time is defined as Y_{cen}. Next, an average value of Y is obtained for a region of 100 pixels in total with 50 pixels at both ends centering on X_{cen}, and the average value is defined as a baseline (Y_{base}). Then, Y′ is obtained by correcting the data Y according to the following formula so that Y_{cen}=100 and Y_{base}=0.

Y′=(Y−Y_{base})×100/(Y_{cen}−Y_{base}) [Mathematical Formula 8]

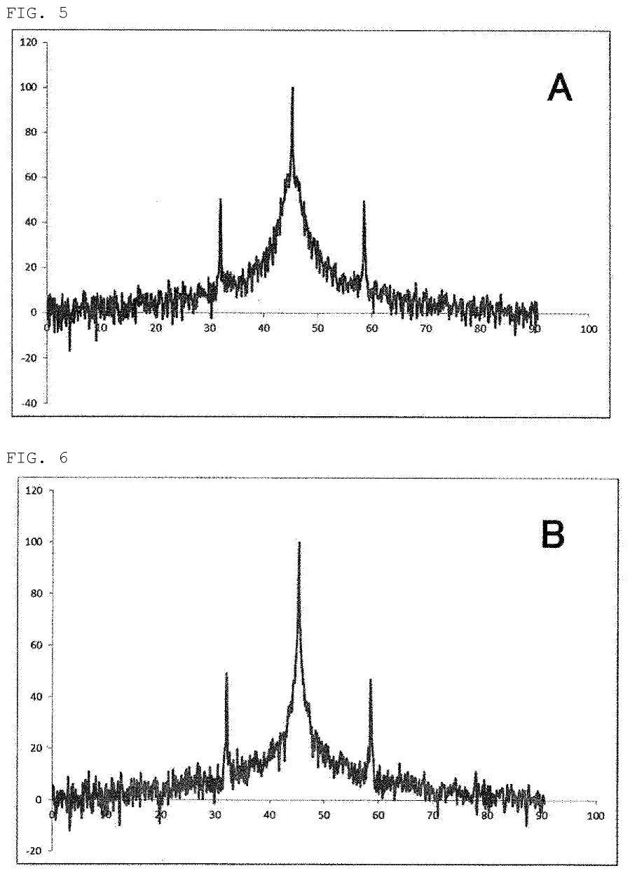

By performing the above correction on the line profile (data Y) obtained in Example 1 shown in FIG. 4, a line profile A (data Y′) as shown in FIG. 5 is obtained.

Next, the same operation was performed on the background image obtained in 1 to obtain a line profile of the background image. Specifically, a line profile B as shown in FIG. 6 was obtained.

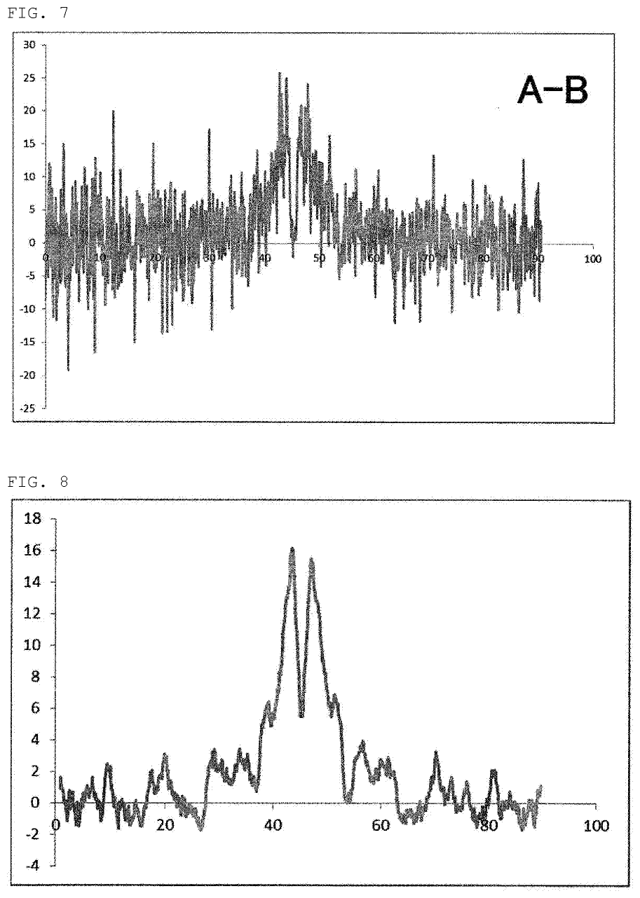

Next, blank correction was performed by subtracting the profile B of the background from the profile A using Excel. In Example 1, the data of the line profile B as shown in FIG. 6 was subtracted from the data Y′ of the line profile A shown in FIG. 5 to obtain a line profile A-B subjected to blank correction as shown in FIG. 7.

The thus-obtained line profile was smoothed to obtain a profile of Y″, which was used to measure the maximum intensities (Yₘₕ₁ and Yₘᵥ₁) of the line profile. The smoothing of the graph was performed by calculating yᵢ as an average value of 21 pieces of data according to the following formula.

yᵢ=(Y″ᵢ₋₁₀+Y″ᵢ₋₉+ . . . +Y″ᵢ₋₁+Y″+Y″ᵢ₊₁+ . . . +Y″ᵢ₊₉+Y″ᵢ₊₁₀)/21 [Mathematical Formula 9]

(Sensory Evaluation of Visibility)

In a room environment adjusted to 50 to 100 lux, the produced film was visually inspected from an elevation angle of 80°, and the visibility was evaluated based on the distortion of the reflected background. The results are indicated in Table 2. In addition, the criteria for evaluation of visibility are as follows.

∘: No distortion was confirmed in the background.

Δ: Slight distortion was confirmed in the background.

X: A clear distortion was confirmed in the background.

### Manufacture Example 1: Manufacture of Polyimide Varnish Containing Polyimide-Based Polymer (1)

A reactor in which a separable flask was equipped with a silica gel tube, a stirrer and a thermometer, and an oil bath were prepared. In this flask, 75.52 g of 4,4′-(hexafluoroisopropylidene) diphthalic dianhydride (6FDA) and 54.44 g of 2,2′-bis (trifluoromethyl)-4,4′-diaminodiphenyl (TFMB) were charged. While stirring this at 400 rpm, 519.84 g of DMAc was added thereto, and stirring was continued until the contents of the flask were mixed to form a homogeneous solution. Subsequently, stirring was further continued for 20 hours while adjusting the temperature in the container to be in the range of 20 to 30° C. using an oil bath, and a reaction was caused to produce polyamic acid. After 30 minutes, the stirring speed was changed to 100 rpm. After stirring for 20 hours, the reaction system temperature was returned to room temperature, and DMAc (649.8 g) was added to adjust the polymer concentration to 10% by mass. Furthermore, 32.27 g of pyridine and 41.65 g of acetic anhydride were added, and the mixture was stirred at room temperature for 10 hours for imidization. A polyimide varnish was taken out from the reaction vessel. The obtained polyimide varnish was dropped into methanol for reprecipitation, and the obtained powder was dried by heating to remove the solvent, thereby obtaining a polyimide-based polymer (1) as a solid content. The obtained polyimide-based polymer (1) was subjected to GPC measurement. As a result, the weight average molecular weight was 320,000. The imidization rate of polyimide was 98.6%. The polyimide-based polymer was dissolved at a concentration of 16.5% in a solvent in which γ-butyrolactone and N,N-dimethylacetamide were mixed at 1:9 to obtain a polyimide varnish (1).

### Manufacture Example 2: Manufacture of Polyimide Varnish Containing Polyimide-Based Polymer (2)

In the same manner as in Manufacture Example 1, a polyimide-based polymer (2) having a weight average molecular weight of 280,000 and an imidization rate of 98.3% was manufactured and dissolved in the same manner as in Manufacture Example 1 except that the concentration was changed to 17.8%, thereby obtaining a polyimide varnish (2).

### Manufacture Example 3: Manufacture of Polyimide Varnish Containing Polyimide-Based Polymer (3)

In the same manner as in Manufacture Example 1, a polyimide-based polymer (3) having a weight average molecular weight of 305,000 and an imidization rate of 98.5% was manufactured and dissolved in the same manner as in Manufacture Example 1 except that the concentration was changed to 16.9%, thereby obtaining a polyimide varnish (3).

### Manufacture Example 4: Manufacture of Polyimide Varnish Containing Polyimide-Based Polymer (4)

In the same manner as in Manufacture Example 1, a polyimide-based polymer (4) having a weight average molecular weight of 400,000 and an imidization rate of 98.3% was manufactured and dissolved in the same manner as in Manufacture Example 1 except that the concentration was changed to 16%, thereby obtaining a polyimide varnish (4).

### Manufacture Example 5: Manufacture of Polyimide Varnish Containing Polyimide-Based Polymer (5)

In a nitrogen atmosphere, 0.50 isoquinoline was charged into a reaction vessel connected to a vacuum pump equipped with a solvent trap and a filter. Next, 375.00 g of γ-butyrolactone (GBL) and 104.42 g of 2,2′-bis (trifluoromethyl)-4,4′-diaminodiphenyl (TFMB) were charged in the reaction vessel and stirred until completely dissolved. Further, 145.58 g of 4,4′-(hexafluoroisopropylidene) diphthalic dianhydride (6FDA) was added, and temperature rising was initiated in an oil bath while stirring. When the internal temperature reached 80° C., the pressure was reduced to 650 mmHg, and then the internal temperature was raised to 180° C., followed by heating and stirring. Thereafter, the pressure was restored to atmospheric pressure, and the temperature was cooled to 155° C. to obtain a polyimide solution. GBL was added at 155° C. to obtain a uniform solution having a polyimide solid content of 24 wt %. Then, a polyimide varnish was taken out from the reaction vessel. The obtained polyimide varnish was dropped into methanol for reprecipitation, and the obtained powder was dried by heating to remove the solvent, thereby obtaining a polyimide-based polymer (5) as a solid content. The weight average molecular weight was 114,000, and the imidization rate was 99.6%. The polyimide-based polymer was dissolved at a concentration of 18% in a solvent in which γ-butyrolactone and N,N-dimethylacetamide were mixed at 9:1 to obtain a polyimide varnish (5).

### Manufacture Example 6: Manufacture of Polyimide Varnish Containing Polyimide-Based Polymer (6)

Synthesis was performed in the same manner as in Manufacture Example 5 to obtain a polyimide-based polymer (6) having a weight average molecular weight of 120,000 and an imidization rate of 99.7%, and a polyimide varnish (6) was prepared in the same manner except that the concentration was changed to 17.5%.

### Manufacture Example 7: Manufacture of Polyamideimide Varnish Containing Polyamideimide-Based Polymer (1)

In a nitrogen gas atmosphere, 45 g (140.52 mmol) of TFMB and 768.55 g of DMAc were added to a 1-L separable flask equipped with a stirring blade, and TFMB was dissolved in DMAc while stirring at room temperature. Next, 18.92 g (42.58 mmol) of 6FDA was added to the flask and stirred at room temperature for 3 hours. Thereafter, 4.19 g (14.19 mmol) of 4,4′-oxybis (benzoyl chloride) (OBBC) and then 17.29 g (85.16 mmol) of terephthaloyl chloride (TPC) were added to the flask and stirred at room temperature for 1 hour.

Next, 4.63 g (49.68 mmol) of 4-methylpyridine and 13.04 g (127.75 mmol) of acetic anhydride were added to the flask, and stirred at room temperature for 30 minutes. Then, the mixture was heated to 70° C. using an oil bath and further stirred for 3 hours to obtain a reaction solution.

The obtained reaction solution was cooled to room temperature, poured into a large amount of methanol in a thread-like form. The deposited precipitate was taken out, immersed in methanol for 6 hours, and washed with methanol. Next, the precipitate was dried under reduced pressure at 100° C. to obtain a polyamideimide resin. The obtained polyamideimide resin had a weight average molecular weight of 400,000. The polyamideimide-based polymer was dissolved in N,N-dimethylacetamide at a concentration of 10.6% to obtain a polyamideimide varnish (1).

### Manufacture Example 8: Manufacture of Polyamideimide Varnish Containing Polyamideimide-Based Polymer (2)

In a nitrogen gas atmosphere, 45 g (140.52 mmol) of TFMB and 768.55 g of DMAc were added to a 1-L separable flask equipped with a stirring blade, and TFMB was dissolved in DMAc while stirring at room temperature. Next, 19.01 g (42.79 mmol) of 6FDA was added to the flask and stirred at room temperature for 3 hours. Thereafter, 4.21 g (14.26 mmol) of OBBC and then 17.30 g (85.59 mmol) of terephthaloyl chloride (TPC) were added to the flask and stirred at room temperature for 1 hour. Next, 4.63 g (49.68 mmol) of 4-methylpyridine and 13.04 g (127.75 mmol) of acetic anhydride were added to the flask, and stirred at room temperature for 30 minutes. Then, the mixture was heated to 70° C. using an oil bath and further stirred for 3 hours to obtain a reaction solution.

The obtained reaction solution was cooled to room temperature, poured into a large amount of methanol in a thread-like form. The deposited precipitate was taken out, immersed in methanol for 6 hours, and washed with methanol. Next, the precipitate was dried under reduced pressure at 100° C. to obtain a polyamideimide resin. The obtained polyamideimide resin had a weight average molecular weight of 365,000. The polyamideimide-based polymer was dissolved in N,N-dimethylacetamide at a concentration of 11.0% to obtain a polyamideimide varnish (2).

### Example 1

The polyimide varnish (1) obtained in Manufacture Example 1 was formed into a coating by casting molding on a PET (polyethylene terephthalate) film (“A4100” manufactured by Toyobo Co., Ltd., film thickness 180 μm, film thickness distribution±2 μm). The linear velocity was 0.4 m/min. The coating was dried by heating at 70° C. for 7.5 minutes, 120° C. for 7.5 minutes, 70° C. for 7.5 minutes, and 75° C. for 7.5 minutes, and peeled off from the PET film. Thereafter, the coating was heated (post-baked) at 200° C. for 25 minutes to obtain a polyimide film having a thickness of 77 μm.

### Example 2

A polyimide film having a thickness of 82 μm was obtained in the same manner as in Example 1 except that the polyimide varnish (2) was used.

### Example 3

A polyimide film having a thickness of 77 μm was obtained in the same manner as in Example 1 except that the polyimide varnish (3) was used and that the coating was dried by heating at 70° C. for 7.5 minutes, 120° C. for 7.5 minutes, 87° C. for 7.5 minutes, and 80° C. for 7.5 minutes.

### Example 4

A polyamideimide film having a thickness of 76 μm was obtained in the same manner as in Example 1 except that the polyamideimide varnish (1) was used and that the coating was dried by heating at 80° C. for 9.0 minutes, 110° C. for 9.5 minutes, 90° C. for 9.5 minutes, and 80° C. for 7.5 minutes.

### Example 5

A polyamideimide film having a thickness of 74 μm was obtained in the same manner as in Example 1 except that the polyamideimide varnish (2) was used and that the coating was dried by heating at 80° C. for 9.0 minutes, 110° C. for 9.5 minutes, 90° C. for 9.5 minutes, and 80° C. for 7.5 minutes.

### Comparative Example 1

The polyimide varnish (4) was formed into a coating by casting molding on a polyimide film (“UPIREX-125S” manufactured by Ube Industries, Ltd., film thickness 125 μm, film thickness distribution±5 μm). The linear velocity was 0.3 m/powder. Then, the coating was dried by heating at 60° C. for 20 minutes and at 80° C. for 13 minutes, and peeled off from the polyimide film. Thereafter, the coating was heated at 200° C. for 25 minutes to obtain a polyimide film having a thickness of 78 μm.

### Comparative Example 2

A polyimide film having a thickness of 80 μm was obtained in the same manner as in Example 1 except that the polyimide varnish (5) was used and that the coating was dried by heating at 120° C. for 15 minutes, 72° C. for 7.5 minutes, and 67° C. for 7.5 minutes.

### Comparative Example 3

A polyimide film having a thickness of 84 μm was obtained in the same manner as in Example 1 except that the polyimide varnish (6) was used and that the coating was dried by heating at 120° C. for 15 minutes, 80° C. for 7.5 minutes, and 75° C. for 7.5 minutes.

The viscosity and resin concentration of the respective polyimide varnishes and polyamideimide varnishes obtained as described above were measured according to the above methods. Moreover, the film thickness, total light transmittance and Haze of the film obtained from each of the varnishes were measured according to the above methods. The results obtained are indicated in Table 1 below. The films were evaluated for optical homogeneity and visibility according to the above method. The results obtained are indicated in Table 2 below.

TABLE 1

| | | Varnish | | | Film | | |
|---|---|---|---|---|---|---|---|
| | | | Resin | Viscosity × | Film | Total light | |
| | | Viscosity | concentration | resin | thickness | transmittance | Haze |
| | | [cps] | [% by mass] | concentration | [μm] | [%] | [%] |
| Example | 1 | 35,000 | 16.5 | 5,775 | 77 | 92 | 0.2 |
| | 2 | 35,000 | 17.8 | 6,230 | 82 | 92 | 0.3 |
| | 3 | 34,000 | 16.9 | 5,746 | 77 | 93 | 0.1 |
| | 4 | 40,000 | 10.3 | 4,120 | 76 | 92 | 0.2 |
| | 5 | 36,500 | 11.0 | 4,015 | 74 | 92 | 0.2 |
| Comparative | 1 | 31,000 | 16.0 | 4,960 | 78 | 93 | 0.2 |
| Example | 2 | 16,500 | 18.0 | 2,970 | 80 | 92 | 0.2 |
| | 3 | 14,000 | 17.5 | 2,450 | 84 | 92 | 0.2 |

TABLE 2

| | | | Xₘₕ | | Xₘᵥ | A: Yₘₕ + | B: (Xₘₕ + | | |
|---|---|---|---|---|---|---|---|---|---|
| | | Yₘₕ | [cm⁻¹] | Yₘᵥ | [cm⁻¹] | Yₘᵥ | Xₘᵥ)^{1/2} | A/B | Visibility |
| Example | 1 | 16.2 | 1.77 | 10.7 | 1.51 | 26.9 | 1.8 | 14.9 | ∘ |
| | 2 | 20.6 | 2.12 | 14.0 | 1.35 | 34.6 | 1.9 | 18.2 | ∘ |
| | 3 | 24.4 | 2.04 | 22.2 | 4.62 | 46.6 | 2.6 | 17.9 | ∘ |
| | 4 | 27.0 | 2.2 | 17.0 | 12.4 | 44.0 | 3.8 | 11.5 | ∘ |
| | 5 | 4.8 | 3.2 | 13.3 | 12.6 | 18.6 | 4.0 | 4.5 | ∘ |
| Comparative | 1 | 36.6 | 3.19 | 23.2 | 4.54 | 59.8 | 2.8 | 21.4 | Δ |
| Example | 2 | 48.9 | 2.83 | 15.3 | 1.59 | 64.2 | 2.1 | 30.6 | x |
| | 3 | 48.9 | 2.12 | 17.3 | 1.59 | 66.2 | 1.9 | 34.8 | x |

The polyimide-based films of Examples 1 to 5 had an A/B of less than 20, and their visibility evaluations were all good. The polyimide-based films of Comparative Examples 1 to 3 had an A/B of 20 or more, and the visibility evaluation results were either Δ or x.

### DESCRIPTION OF REFERENCE SIGNS

1 Light source
2 Film
3 Projection plane
4 Projection image
5 Light
6 Camera
7 Camera angle

1. A cast film containing a resin having a weight average molecular weight of 200,000 or more,
wherein, when line profiles in a direction h and a direction v which are orthogonal to each other in a film inverse space image obtained by Fourier transforming a projection image obtained by a projection method using the cast film are a line profile h and a line profile v, respectively;
line profiles in a direction h′ and a direction v′ which are orthogonal to each other in a background inverse space image obtained by Fourier transforming a background image obtained without using the cast film in the projection method are a line profile h′ and a line profile v′, respectively;
a maximum intensity of a line profile (h−h′) obtained by subtracting the line profile h′ from the line profile h is Yₘₕ;
a frequency indicating the maximum intensity Yₘₕ is Xₘₕ;
a maximum intensity of a line profile (v−v′) obtained by subtracting the line profile v′ from the line profile v is Yₘᵥ; and
a frequency indicating the maximum intensity Yₘᵥ is Xₘᵥ,
Yₘₕ and Yₘᵥ are both 30 or less, and
Yₘₕ, Yₘᵥ, Xₘₕ and Xₘᵥ satisfy the following relationship:
(Yₘₕ+Yₘᵥ)/(Xₘₕ+Xₘᵥ)^{1/2}<20 [Mathematical Formula 1].

2. The cast film according to claim 1, wherein the resin is polyimide or polyamideimide.

3. A method for evaluating the optical homogeneity of a film, comprising at least the steps of:
(1) obtaining a projection image by a projection method in which light from a light source is irradiated onto a film and light transmitted through the film is projected onto a projection plane;
(2) projecting light from the light source onto the projection plane without using the film in the projection method of step (1) to obtain a background image;
(3) quantifying each of the projection image obtained in step (1) and the background image obtained in step (2) through gray scale conversion and Fourier transforming the quantified image data to obtain inverse space images;
(4) subtracting line profiles in two directions orthogonal to each other in the inverse space image of the background image from line profiles in the two directions orthogonal to the inverse space image of the projection image to obtain blank-corrected line profiles; and
(5) measuring maximum intensities (Yₘₕ and Yₘᵥ) of the blank-corrected line profiles obtained in step (4).

4. A method for manufacturing a film, comprising at least the steps of:
applying a varnish containing at least a resin and a solvent to a support;
drying the varnish coating to obtain a film, and
evaluating the film using the method for evaluating according to claim 3.

5. The method for manufacturing a film according to claim 4, wherein, in the step of evaluating the film, the optical homogeneity of the film is evaluated based on the maximum strengths (Yₘₕ and Yₘᵥ) measured by the method for evaluating according to claim 3, and the quality of the film is determined.
